(19) United States
(12) Patent Application Publication
(10) Pub. No.: US 2022/0258406 A1
(43) Pub. Date: Aug. 18, 2022

(54) Fiber-Reinforced Thermoplastic Laminate

(71) Applicant: Tanso, Inc., Oakland, CA (US)

(72) Inventor: Hemant Bheda, Saratoga, CA (US)

(73) Assignee: Tanso, Inc., Oakland, CA (US)

(21) Appl. No.: 17/669,999

(22) Filed: Feb. 11, 2022

Related U.S. Application Data
(60) Provisional application No. 63/149,263, filed on Feb. 13, 2021.
(60) Provisional application No. 63/170,095, filed on Apr. 2, 2021.

(51) Int. Cl. B29C 51/02; B32B 5/12; B29B 11/16; B29C 51/14; B32B 38/00

(52) U.S. Cl. CPC B29C 51/02; B32B 5/12; B32B 38/0004; B29C 51/14; B29B 11/16

(57) ABSTRACT

A fiber-reinforced thermoplastic laminate is disclosed that comprises continuous reinforcing fiber. The laminate is custom designed and fabricated to be molded into a specific article of manufacture. Some or all of the continuous reinforcing fiber are severed at precise locations based on the geometric and physical requirements of the article of manufacture to facilitate molding while preserving most of the strength provided by continuous reinforcing fiber.

### CROSS-REFERENCE TO RELATED APPLICATIONS

The application claims the benefit of:
(i) U.S. Provisional Patent Application Ser. No. 63/149,263, (Attorney Docket 5011-001pr1), which is incorporated by reference in its entirety, and
(ii) U.S. Provisional Patent Application Ser. No. 63/170,095, (Attorney Docket 5011-002pr1), which is incorporated by reference in its entirety.

### FIELD OF THE INVENTION

The present invention relates to composite manufacturing in general, and, to fiber-reinforced thermoplastic laminates in particular.

### BACKGROUND OF THE INVENTION

A popular method of manufacturing involves:
(1) heating a sheet of thermoplastic until it is pliable,
(2) using a vacuum to force the sheet of thermoplastic to stretch and conform to a mold, and
(3) cooling the thermoplastic so that it permanently assumes the shape of the mold.
   In general, this method of manufacturing is called “thermoforming.”

In some cases, the sheet comprises one layer of thermoplastic, but in other cases the sheet comprises two or more layers of thermoplastic and reinforcing fiber. When the sheet comprises two or more layers of thermoplastic and reinforcing fiber, it is called a “fiber-reinforced thermoplastic laminate.” Fiber-reinforced thermoplastic laminates are sometimes known as “organo sheets” or “RTL's.”

### SUMMARY OF THE INVENTION

Some embodiments of the present invention enable the fabrication of an article of manufacture from a fiber-reinforced thermoplastic laminate without some of the costs and disadvantages for doing so in the prior art.

In general, there are two types of reinforcing fiber in a fiber-reinforced thermoplastic laminate: “continuous fiber” and “chopped fiber.” In general:
(i) continuous fiber is much longer than chopped fiber, and
(ii) the directional orientation of continuous fiber is carefully controlled—so that adjacent fibers are parallel or follow a related curve, whereas the directional orientation of continuous fiber is haphazard or random, and
(iii) continuous fiber adds more strength to the finished article of manufacture than chopped fiber.

The inclusion of chopped fiber in a laminate generally does not cause complications during thermoforming, but the inclusion of continuous fiber does. In some cases, the inclusion of continuous fiber in a laminate prevents the laminate from properly deforming and assuming the shape of the mold. The illustrative embodiment of the present invention addresses this issue.

In accordance with the illustrative embodiment, a non-planar article of manufacture is designed that is to be thermoformed or otherwise molded from a fiber-reinforced thermoplastic laminate. As part of the design process, an engineer considers:
(i) the desired utility of the article; and
(ii) the desired aesthetics of the article (e.g., surface finish, etc.); and
(iii) the desired physical (e.g., structural, thermal, electromagnetic, etc.) attributes of the article; and
(iv) the desired material and production costs to fabricate the article
   in order to produce:
(a) a complete specification of the required geometry of the article; and
(b) a complete specification of the physical (e.g., structural, thermal, electromagnetic, etc.) requirements of the article; and
(c) a complete specification of the economic requirements for fabricating the article; and
(d) a complete specification of the post-processing requirements of the article.

After the article is designed, the engineer must consider the question of what laminate should be used to fabricate the article. Although there are many different fiber-reinforced thermoplastic laminates that are commercially available off-the-shelf, some articles cannot be made from them. The article of manufacture shown in FIGS. 2a, 2b, 2c, and 2d, and described in the Detailed Description is one of them.

Therefore, in accordance with the illustrative embodiment, an engineer next produces a fully-custom design for a fiber-reinforced thermoplastic laminate from which the article can be fabricated.

As part of this task, the engineer considers:
(i) the required geometry of the article in general, and, in particular, how the different portions of the laminate must deform during thermoforming to conform to the contour of the mold; and
(ii) the physical requirements of the article in general, and, in particular, whether the laminate will satisfy the physical requirements of the article after the laminate has been deformed during thermoforming; and
(iii) the economic requirements of the article; and
(iv) the post-processing requirements of the article
   to produce a complete specification of the laminate, which includes, among other things:
(i) a description of the overall dimensions of the laminate; and
(ii) a description of the number of layers that will compose the laminate; and
(iii) a description of whether each layer comprises:
   thermoplastic embedded with reinforcing fiber, or
   thermoplastic without reinforcing fiber, or
   reinforcing fiber without thermoplastic; and
(iv) a description of the overall dimensions of each layer; and
(v) for each layer that comprises a thermoplastic, a description of which thermoplastic(s) will compose that layer; and
(vi) for each layer that comprises reinforcing fiber, a description of the chemical makeup of the reinforcing fiber (e.g., carbon, glass, aramid, hemp, etc.); and
(vii) for each layer that comprises reinforcing fiber, a description of whether the reinforcing fiber are continuous or chopped; and
(viii) for each layer that comprises reinforcing fiber, a description of the number or density of the fiber; and
(ix) for each layer that comprises continuous reinforcing fiber, a description of whether the reinforcing fiber are unidirectional or multidirectional; and
(x) for each layer that comprises continuous reinforcing fiber, a description of the angular orientation of the fiber; and
(xi) for each layer that comprises continuous reinforcing fiber, a description of whether any of the continuous fibers are to be severed; and if so where the cuts should be; and
(xii) a description of whether metallic or thermoplastic inserts are included; and
(xiii) a description of whether reinforcing thermoplastic patches are included.

In accordance with the illustrative embodiment, the laminate comprises three layers:
(1) a top layer of thermoplastic that is embedded with continuous carbon reinforcing fiber, and
(2) a middle layer of thermoplastic without reinforcing fiber, and
(3) a bottom layer of thermoplastic that is embedded with continuous carbon reinforcing fiber that is at a 90° angle to the fiber in the top layer.
   The engineer included continuous fiber in the top and bottom layers to provide the finished article of manufacture with tensile strength and bending resistance.

In order to ensure that the continuous fiber does not inhibit deformation during thermoforming, some of the fibers in the top and bottom layers are severed at precise locations (as depicted, for example, in FIGS. 17 and 18) before the laminate itself is assembled and fabricated. The location of the cuts is based on:
(i) the required geometry of the finished article of manufacture in general, and, in particular, how the different portions of the laminate must deform and be displaced to conform to the mold during thermoforming; and
(ii) the physical requirements of the finished article of manufacture in general, and, in particular, whether the thermoformed laminate will satisfy the physical requirements of the article of manufacture.

The relative position of the cuts in the top layer with respect to the position of the cuts in the bottom layer must be precisely aligned, and, therefore, the engineer adds two corresponding registration marks to both layers. This facilitates the precise positioning of the cuts in the top layer with the cuts in the bottom layer when the when the layers are assembled into the layup prior to consolidation.

Furthermore, the relative position of the cuts in the laminate relative to the contours of the mold must be precisely aligned, and, therefore, the engineer adds two corresponding registration marks to the top of the laminate and to the clamping frame. This facilitates the precise positioning of the laminate with the mold when the laminate is positioned in the clamping frame prior to heating and molding.

After the laminate is designed, an engineer next designs a mold, clamping frame, and post-processing dies, in well-known fashion. Afterwards, the mold, clamping frame, and post-processing dies are fabricated, also in well-known fashion.

Next, the laminate is fabricated. The top layer is cut to size, the fibers are severed by a laser, at the specified locations, and the registration marks are added. The middle layer is cut to size. The bottom layer is cut to size, its fibers are severed by the laser, at the specified locations, and the registration marks are added. The three layers are then assembled into the layup—while using the registration marks to precisely align the cuts in the top layer with the cuts in the bottom layer, and then the layup is heated and consolidated.

Next the laminate is clamped in the clamping frame while using the registration marks to precisely align the cuts in the laminate with the clamping frame, whose location to the mold is precisely controlled. Then the laminate is heated, deformed by the mold with the assistance of a vacuum and ambient air pressure, and allowed to cool and harden.

Lastly, the article is removed from the mold and post-processed in well-known fashion.

### BRIEF DESCRIPTION OF THE DRAWINGS

FIG. 1 depicts a flowchart of the salient tasks associated with the illustrative embodiment of the present invention.

FIG. 2a depicts an orthographic top view of cover 200, drawn to scale, as shown.

FIG. 2b depicts an orthographic bottom view of cover 200, drawn to scale as shown.

FIG. 2c depicts an orthographic front view of cover 200, drawn to scale as shown.

FIG. 2d depicts an orthographic side view of cover 200, drawn to scale as shown.

FIG. 3 depicts a flowchart of the salient tasks associated with task 102—designing the fiber-reinforced thermoplastic laminate from which cover 200 will be fabricated

FIG. 4a depicts an orthographic top view of first candidate laminate 400, drawn to scale, as shown.

FIG. 4b depicts an orthographic front view of first candidate laminate 400, drawn to scale as shown.

FIG. 5 depicts a vertically-enlarged orthographic front view of first candidate laminate 400 at cross-section DD-DD.

FIG. 6 depicts an orthographic top view of fiber-reinforced thermoplastic layer 501.

FIG. 7 depicts an orthographic top view of fiber-reinforced thermoplastic layer 503.

FIG. 8 depicts a graph of the induced longitudinal tensile stress in one fiber—fiber 600—along its 150.0 length based on the lateral displacement forces on fiber 600 caused during thermoforming.

FIG. 9a depicts an orthographic top view of second candidate laminate 900, drawn to scale, as shown.

FIG. 9b depicts an orthographic front view of second candidate laminate 900, drawn to scale as shown.

FIG. 10 depicts a vertically-enlarged orthographic front view of second candidate laminate 900 at cross-section EE-EE.

FIG. 11 depicts an orthographic top view of fiber-reinforced thermoplastic layer 1001.

FIG. 12 depicts an orthographic top view of fiber-reinforced thermoplastic layer 1003.

FIG. 13 depicts a graph of the induced longitudinal tensile stress in one fiber—fiber 1100.

FIG. 14 depicts an orthographic top view of second candidate laminate 900 after thermoforming depicting the locations where fibers in fiber-reinforced thermoplastic layer 1001 are present and where they are absent.

FIG. 15a depicts an orthographic top view of third candidate laminate 1500, drawn to scale, as shown.

FIG. 15b depicts an orthographic front view of third candidate laminate 1500, drawn to scale as shown.

FIG. 16 depicts a vertically-enlarged orthographic front view of third candidate laminate 1500 at cross-section FF-FF.

FIG. 17 depicts an orthographic top view of fiber-reinforced thermoplastic layer 1601.

FIG. 18 depicts an orthographic top view of fiber-reinforced thermoplastic layer 1603.

FIG. 19 depicts a graph of the induced longitudinal tensile stress in one fiber—fiber 1700.

FIG. 20 depicts an orthographic top view of third candidate laminate 1500 after thermoforming depicting the locations where fibers in fiber-reinforced thermoplastic layer 1601 are present and where they are absent.

FIG. 21 depicts a flowchart of the salient subtasks associated with task 104—fabricating the fiber-reinforced thermoplastic laminate.

FIG. 22 depicts a flowchart of the orthogonal front view of mold 2200, which is a male mold.

FIG. 23 depicts a flowchart of the orthogonal side view of mold 2200.

### DEFINITIONS

Article—For the purposes of this specification, the word “article” and its inflected forms is defined to be a synonym of an “article of manufacture.”

Laminate—For the purposes of this specification, the word “laminate” and its inflected forms is defined to be a synonym of “fiber-reinforced thermoplastic laminate.”

RTL—For the purposes of this specification, the initialism “RTL” and its inflected forms is defined to be a synonym of “fiber-reinforced thermoplastic laminate.”

### DETAILED DESCRIPTION

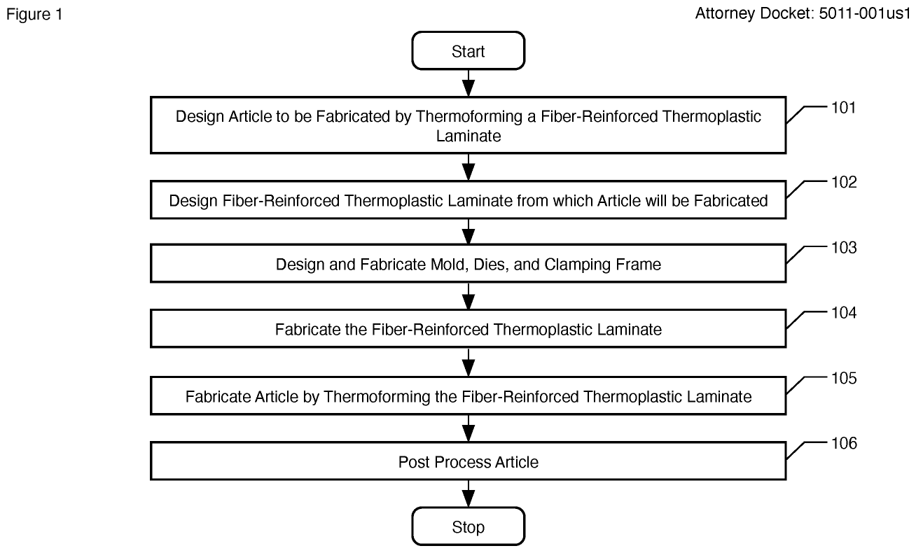

FIG. 1 depicts a flowchart of the salient tasks associated with the illustrative embodiment of the present invention.

At task 101, an engineer with the assistance of a computer-aided design system designs an article of manufacture that is to be fabricated by thermoforming a fiber-reinforced thermoplastic laminate. As part of task 101 the engineer considers:
(i) the desired utility of the article; and
(ii) the desired aesthetics of the article; and
(iii) the desired physical (e.g., structural, thermal, electromagnetic, etc.) attributes of the article; and
(iv) the desired material and production costs to fabricate the article
   in order to produce:
(a) a complete specification of the required geometry of the article; and
(b) a complete specification of the physical (e.g., structural, thermal, electromagnetic, etc.) requirements of the article; and
(c) a complete specification of the economic requirements for fabricating the article; and
(d) a complete specification of the post-processing requirements of the article.
   In accordance with the illustrative embodiment, the article is the cover for a crankcase—cover 200. It will be clear to those skilled in the art, after reading this disclosure, how to make and use alternative embodiments of the present invention that fabricate a different article.

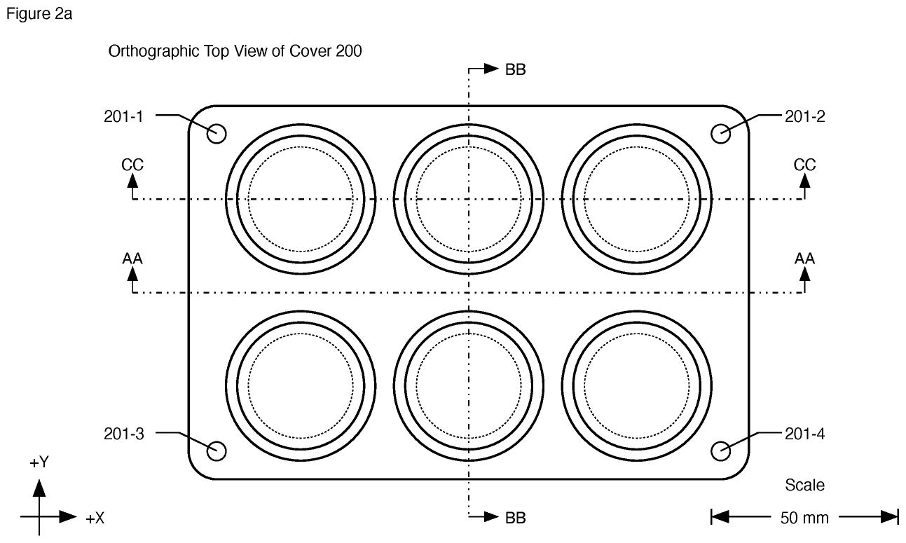

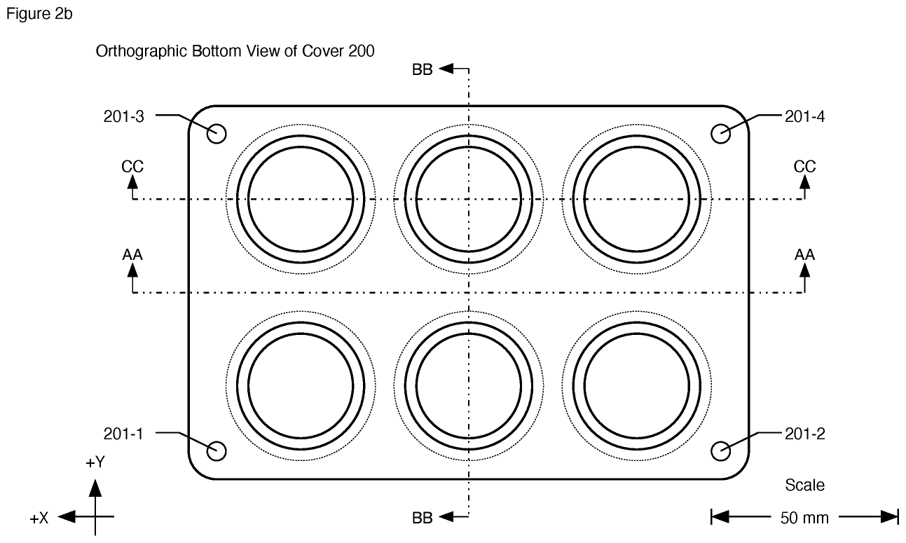

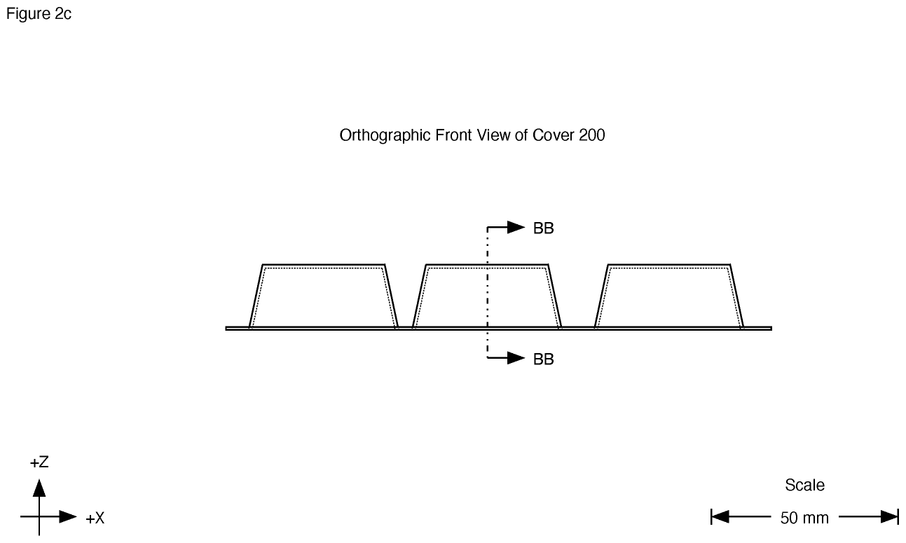

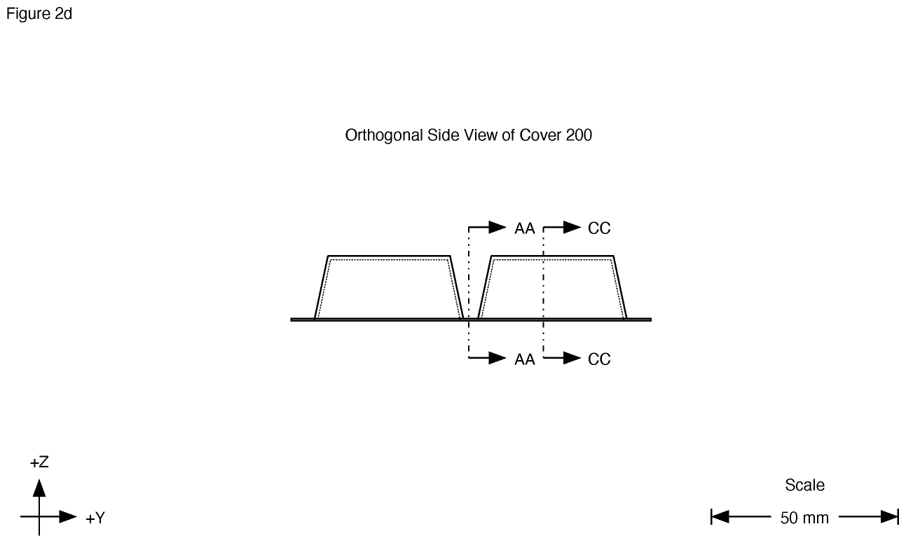

In accordance with the illustrative embodiment, the complete specification of the required geometry of cover is given in FIGS. 2a, 2b, 2c, and 2d, which depict orthographic top, bottom, front, and side views, respectively, of cover 200. Cover 200 is depicted to scale, as shown, and exhibits mirror symmetry across cross-sections AA-AA and BB-BB. Cover 200 is 150.0 wide (Δx) by 100.0 mm high (Δy) by 15.750 mm deep (Δz), and the dimensional tolerances are ±0.100.0 mm. The salient features of cover 200 are six convex (when viewed from the top) concavities and four through holes—through holes 201-1 through 201-4—for bolting cover 200 onto the crankcase. It will be clear to those skilled in the art, after reading this disclosure, how to make and use alternative embodiments of the present invention that have any required geometry.

In accordance with the illustrative embodiment, the complete specification of the physical requirements of cover 200 comprises a detailed specification of the structural properties (e.g., tensile strength, compressive strength, stiffness, modulus, etc.) of each portion of cover 200. It will be clear to those skilled in the art, after reading this disclosure, how to make and use alternative embodiments of the present invention that have any physical requirements.

In accordance with the illustrative embodiment, the complete specification of the post-processing requirements of cover 200 comprises a requirement that through holes 201-1 through 201-4 be drilled out and sanded, that the corners be die cut, and that the top side of cover 200 be sanded and painted. It will be clear to those skilled in the art, after reading this disclosure, how to make and use alternative embodiments of the present invention that have any post-processing requirements.

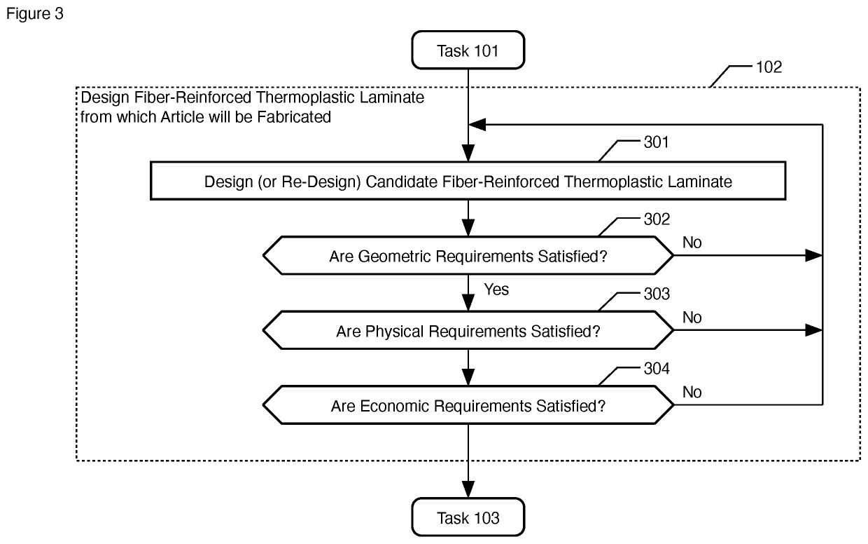

At task 102, the engineer designs a custom fiber-reinforced thermoplastic laminate from which cover 200 will be thermoformed. Task 102 is described in detail in FIG. 3 and the accompanying text.

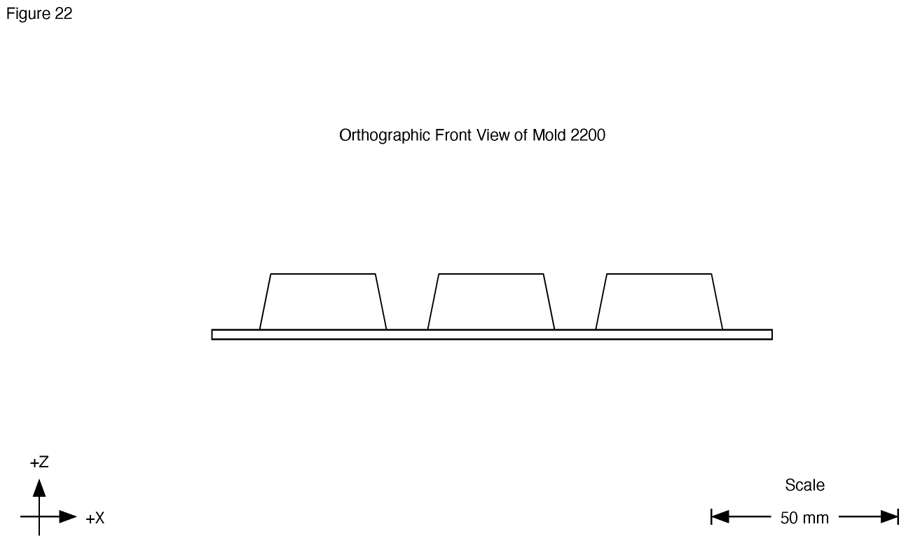

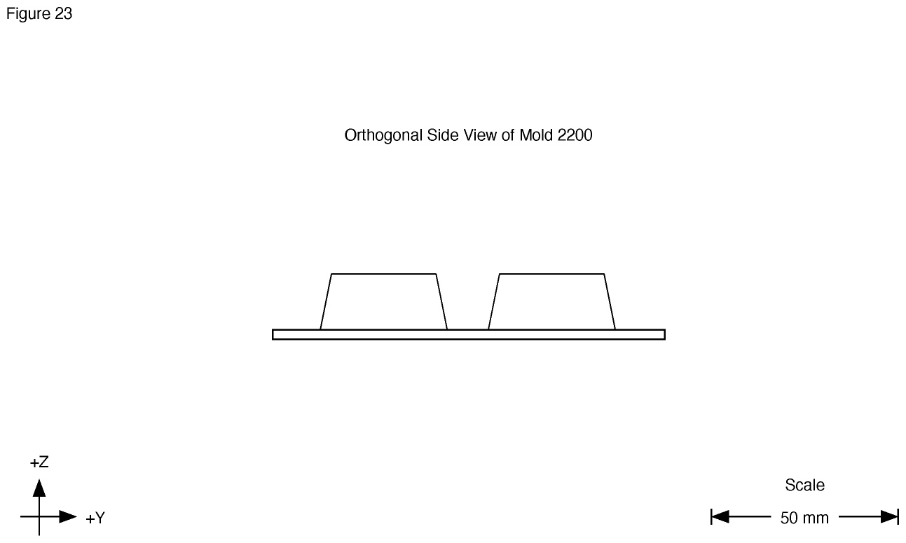

At task 103, the mold, post-processing die, and clamping frame for thermoforming the laminate designed in task 102 is designed and fabricated in well-known fashion. In accordance with the illustrative embodiment, the mold is a “male” mold, as shown in FIGS. 22 and 23, but it will be clear to those skilled in the art, after reading this disclosure, how to make and use alternative embodiments of the present invention in which a female or a hybrid mold is used.

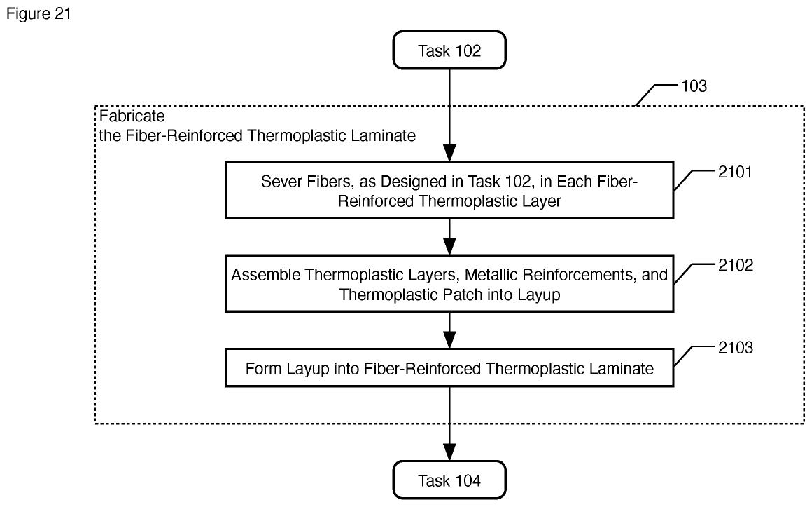

At task 104, the fiber-reinforced thermoplastic laminate that is designed in task 102 is fabricated. Task 104 is described in detail in FIG. 21 and the accompanying text.

At task 105, the article that is designed in task 101 is fabricated by thermoforming the fiber-reinforced thermoplastic laminate that was designed in task 102 and fabricated in task 104. It will be clear to those skilled in the art how to perform task 105.

At task 106, the article that was thermoformed in task 105 is post processed in accordance with the post-processing requirements to produce the finished article of manufacture. It will be clear to those skilled in the art how to perform task 106.

FIG. 3 depicts a flowchart of the salient tasks associated with task 102—designing the fiber-reinforced thermoplastic laminate from which cover 200 will be fabricated.

At task 301, an engineer with a computer-aided design system custom designs a fiber-reinforced thermoplastic laminate that will be thermoformed into cover 200. As part of this task, the engineer considers:
(i) the required geometry of the article in general, and, in particular, how the different portions of the laminate must stretch and be displaced to conform to the contour of the mold; and
(ii) the physical requirements of the article in general, and, in particular, whether the laminate will satisfy the physical requirements of the article after the laminate has been stretched and deformed; and
(iii) the economic requirements of the article; and
(iv) the post-processing requirements of the article
   to produce a complete specification of the laminate, which includes, among other things:
(i) a description of the overall dimensions of the laminate; and
(ii) a description of the number of layers that will compose the laminate; and
(iii) a description of whether each layer comprises:
   thermoplastic embedded with reinforcing fiber, or
   thermoplastic without reinforcing fiber, or
   reinforcing fiber without thermoplastic; and
(iv) a description of the overall dimensions of each layer; and
(v) for each layer that comprises a thermoplastic, a description of which thermoplastic(s) will compose that layer; and
(vi) for each layer that comprises reinforcing fiber, a description of the chemical makeup of the reinforcing fiber (e.g., carbon, glass, aramid, hemp, etc.); and
(vii) for each layer that comprises reinforcing fiber, a description of whether the reinforcing fiber are continuous or chopped; and
(viii) for each layer that comprises reinforcing fiber, a description of the number or density of the fibers; and
(ix) for each layer that comprises continuous reinforcing fiber, a description of whether the reinforcing fiber are unidirectional or multidirectional; and
(x) for each layer that comprises continuous reinforcing fiber, a description of the angular orientation of the fibers; and
(xi) for each layer that comprises continuous reinforcing fiber, a description of whether any continuous fibers are to be severed; and if so where the cuts should be; and
(xii) a description of whether metallic or thermoplastic inserts are included; and
(xiii) a description of whether reinforcing thermoplastic patches are included.

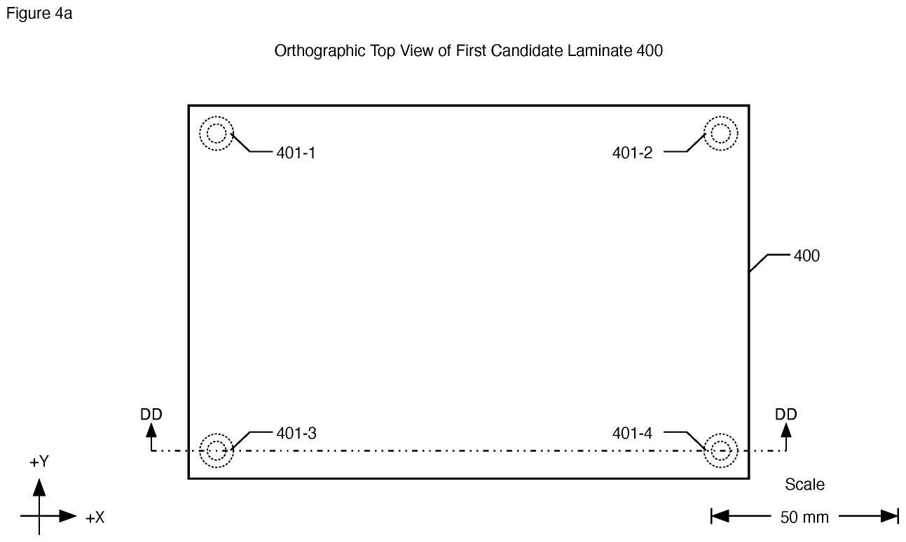

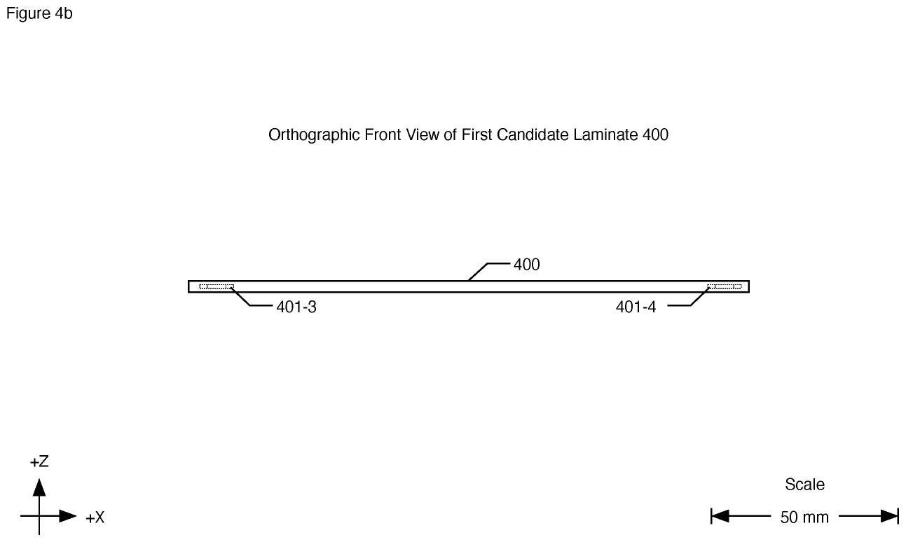

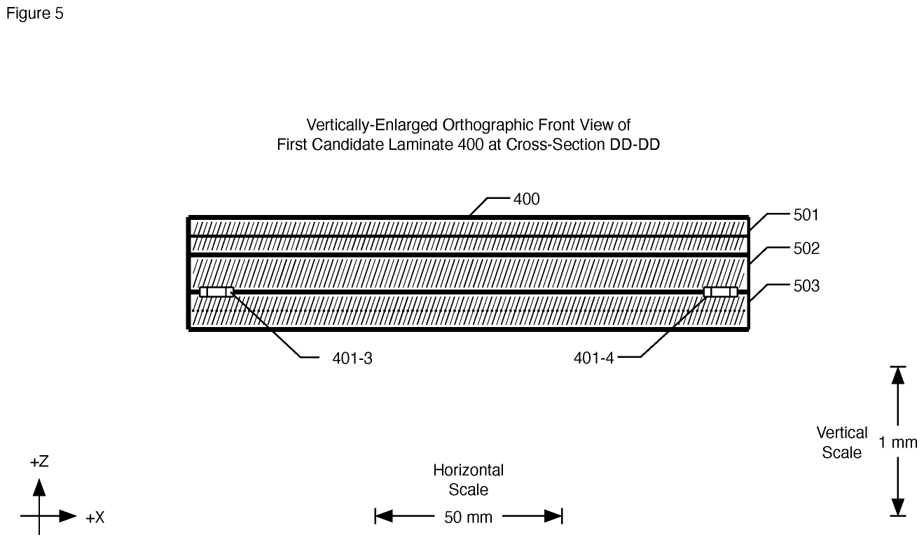

After considering these factors, the engineer produces a first design for the laminate—first candidate laminate 400. FIGS. 4a and 4b depict orthographic top and front views of first candidate laminate 400, and FIG. 5 depicts a vertically-enlarged orthographic front view of first candidate laminate 400 at cross-section DD-DD. To make the composition of first candidate laminate 400 easier for the reader to understand, the vertical (Δz) scale in FIG. 5 is different than the horizontal (Δx) scale. The overall dimensions of first candidate laminate 400 are 150.0 wide (Δx) by 100.0 mm high (Δy) by 0.750 mm thick (Δz). It will be clear to those skilled in the art, after reading this disclosure, how to make and use alternative embodiments of the present invention of any dimension.

First candidate laminate 400 comprises three layers:
(i) fiber-reinforced thermoplastic layer 501, and
(ii) un-reinforced thermoplastic layer 502, and
(iii) fiber-reinforced thermoplastic layer 503, and
   four flat washers:
(iv) flat washer 401-1, and
(v) flat washer 401-2, and
(vi) flat washer 401-3, and
(vii) flat washer 401-4.

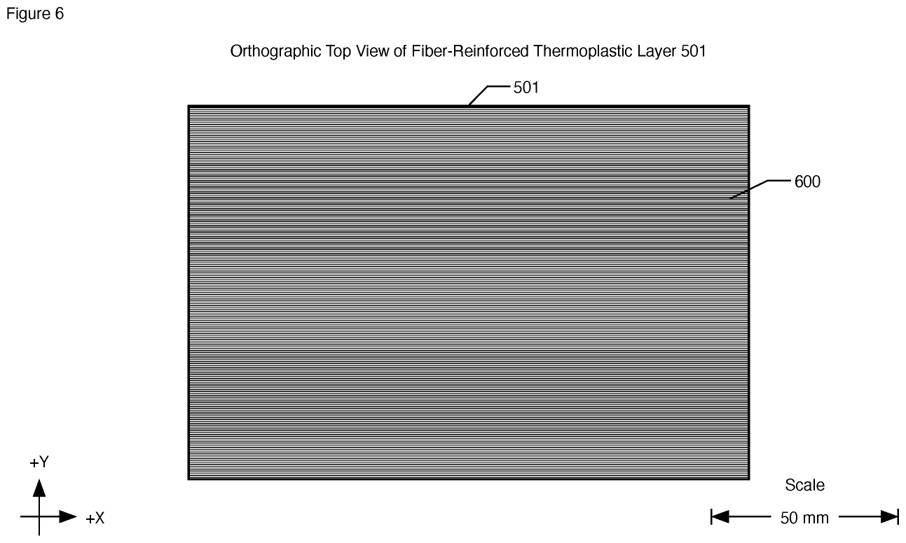

Fiber-Reinforced Thermoplastic Layer 501—The principal purpose of fiber-reinforced thermoplastic layer 501 is to provide:
(i) tensile strength to cover 200 along the X-axis, and
(ii) bending resistance to cover 200 along the Z-axis.
   Because the principal purpose of fiber-reinforced thermoplastic layer 501 is structural, it comprises thermoplastic embedded with continuous reinforcing fiber. FIG. 6 depicts an orthographic top view of fiber-reinforced thermoplastic layer 501. Fiber-reinforced thermoplastic layer 501 is 150.0 wide (Δx) by 100.0 mm high (Δy) by 0.250 mm deep (Δz) with dimensional tolerances of 0.025 mm. Fiber-reinforced thermoplastic layer 501 comprises uni-directional continuous carbon-fiber reinforcement parallel to the X-axis that is wetted with, and embedded in, polyethyletherketone (PEEK). It will be clear to those skilled in the art how to make and use reinforced thermoplastic layer 501.

Un-reinforced Thermoplastic Layer 502—The principal purpose of un-reinforced thermoplastic layer 502 is to provide bulk thermoplastic between reinforced thermoplastic layer 501 and reinforced thermoplastic layer 503. Therefore, un-reinforced thermoplastic layer 502 is devoid of reinforcing fiber. Un-reinforced thermoplastic layer 502 is 150.0 wide (Δx) by 100.0 mm high (Δy) by 0.250 mm deep (Δz) with dimensional tolerances of 0.050 mm. Layer 502 is composed entirely of polyethyletherketone (PEEK). It will be clear to those skilled in the art how to make un-reinforced thermoplastic layer 502.

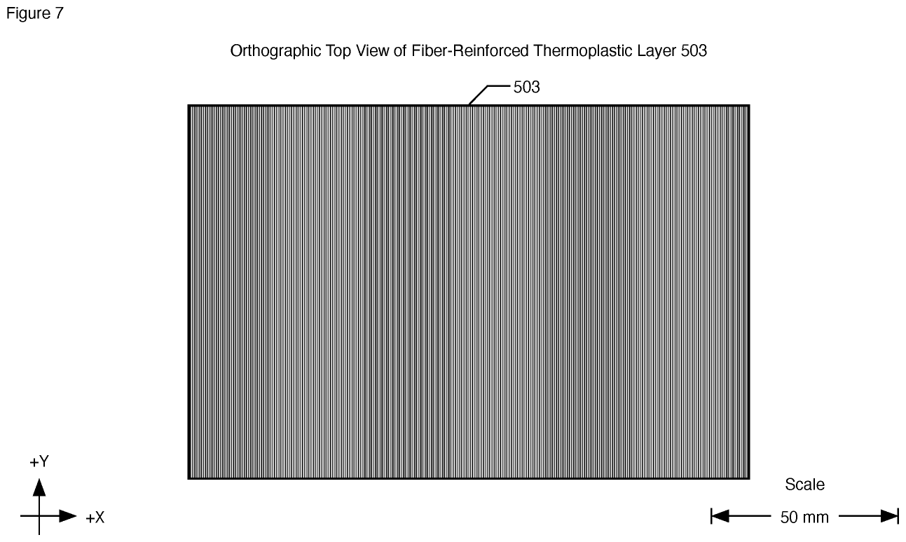

Fiber-Reinforced Thermoplastic Layer 503—The principal purpose of fiber-reinforced thermoplastic layer 503 is to provide:
(i) tensile strength to cover 200 along the Y-axis, and
(ii) bending resistance to cover 200 along the Z-axis.
   Because the principal purpose of fiber-reinforced thermoplastic layer 503 is structural, it comprises thermoplastic embedded with continuous reinforcing fiber. FIG. 7 depicts an orthographic top view of fiber-reinforced thermoplastic layer 503. Fiber-reinforced thermoplastic layer 503 is 150.0 wide (Δx) by 100.0 mm high (Δy) by 0.250 mm deep (Δz) with dimensional tolerances of 0.025 mm. Fiber-reinforced thermoplastic layer 503 comprises uni-directional continuous carbon-fiber reinforcement parallel to the Y-axis that is wetted with, and embedded in, polyethyletherketone (PEEK). It will be clear to those skilled in the art how to make and use reinforced thermoplastic layer 503.

Flat washers 401-1, 401-2, 401-3, and 401-4—The principal purpose of flat washers 401-1, 401-2, 401-3, and 401-4 is to provide reinforcement for through holes 201-1 through 201-4, respectively. It will be clear to those skilled in the art how to make and use flat washers 401-1, 401-2, 401-3, and 401-4.

At task 302, the engineer determines if the article can be thermoformed from first candidate laminate 400 and if the resulting article will satisfy the required geometry of cover 200.

The process of thermoforming attempts to deform first candidate laminate 400—which is substantially planar—into cover 200—which is non-planar—using a vacuum and mold 2200, as shown in FIGS. 22 and 23. The process of deforming a substantially planar laminate into a non-planar article involves applying forces that cause portions of the laminate to stretch and be laterally displaced. The geometry of the article dictates the geometry of the molds, and the geometry of the molds dictates the location, direction, and magnitude of each of these forces.

When a laminate is either:
(i) entirely devoid of fibers, or
(ii) comprises chopped fibers, or
(iii) comprises long or continuous fibers with a very-low tensile strength or high elasticity, or
(iv) any combination of i, ii, and iii
   then the process of thermoforming is relatively straightforward because the presence of the fibers does not cause the laminate to substantially resist deformation.

In contrast, when a laminate comprises continuous or long fibers with a high tensile strength and little elasticity, the fibers might substantially resist deformation. For example, first candidate laminate 400 comprises continuous fibers parallel to the X-axis and the Y-axis. One reason that these fibers are included in first candidate laminate 400 is so that completed cover 200 will resist bending. The presence of those same fibers might, however, also inhibit the molding of first candidate laminate 400 into cover 200.

Therefore, as part of task 302, the engineer determines if the presence and location of reinforcing fiber will prevent first candidate laminate 400 from being thermoformed into an article that satisfies the required geometry of cover 200.

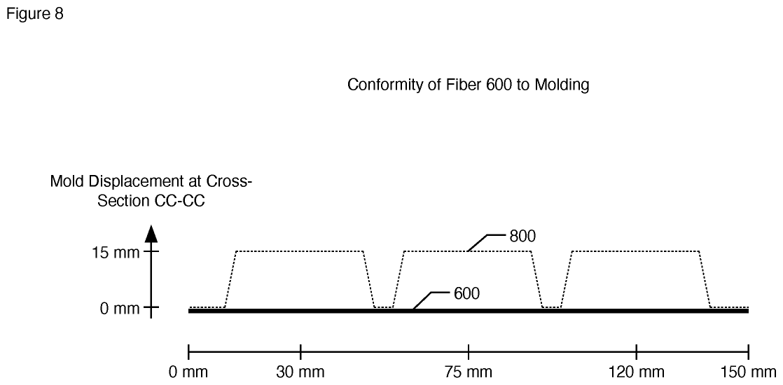

FIG. 8 depicts a diagram of how well one representative fiber in first candidate laminate 400 is predicted to deform during thermoforming. The engineer must perform this analysis on all of the fibers in first candidate laminate 400, but this is the analysis for one representative fiber.

The representative fiber is fiber 600, as shown in FIG. 6. It is located at cross-section CC-CC, as shown in FIGS. 2a, 2b, and 2d. Fiber 600 is 150.0 long and parallel to the X-axis. Fiber 600 is clamped at both ends so that the ends cannot move.

The process of thermoforming attempts to stretch fiber 600 and the thermoplastic with which it is wetted—which is initially straight—into contour 800, which comprises three 15 mm deep concavities.

The length of contour 800 is approximately 222 mm long, but fiber 600 is only 150.0 long. Given that fiber 600 is made of high-tensile-strength continuous carbon fiber, and that the ends of fiber 600 are not going to move, fiber 600 is not going to stretch and conform to contour 800. Therefore, first candidate laminate cannot be thermoformed into an article that will satisfy the required geometry of cover 200.

Therefore, control returns to task 301, where first candidate laminate 400 will be redesigned. It will be clear to those skilled in the art how to perform task 302 on some or all of the fibers in a candidate laminate.

At task 301, an engineer considers why first candidate laminate 400 was unsatisfactory and produces a second design for the laminate—second candidate laminate 900—which the engineer hopes will overcome the deficiencies of first candidate laminate 400.

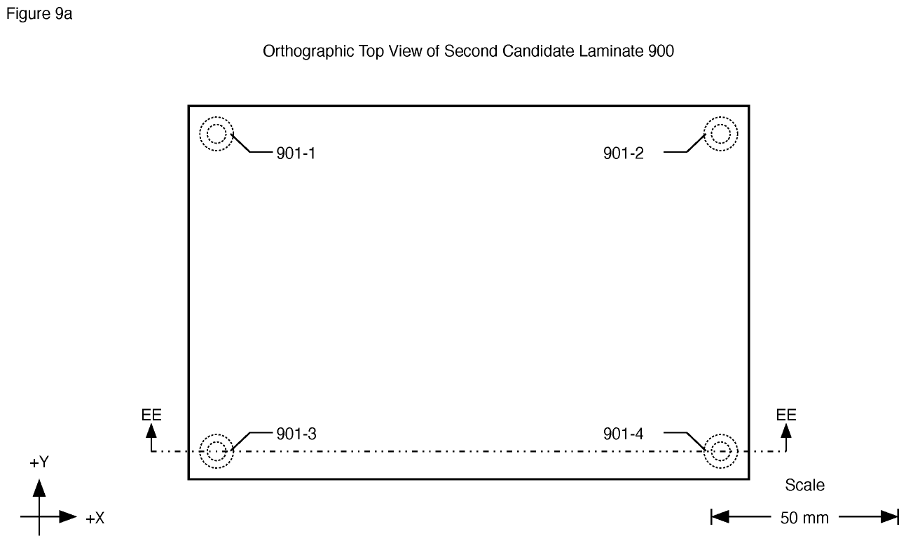

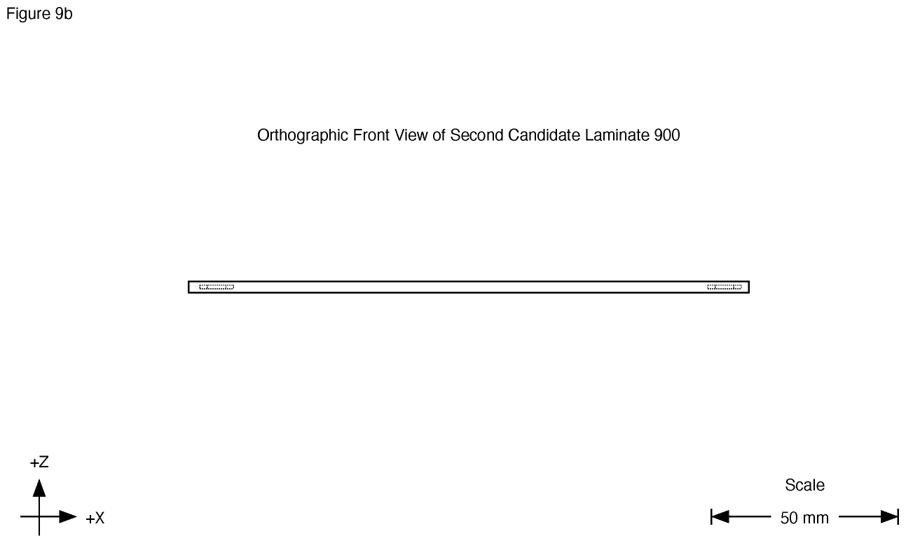

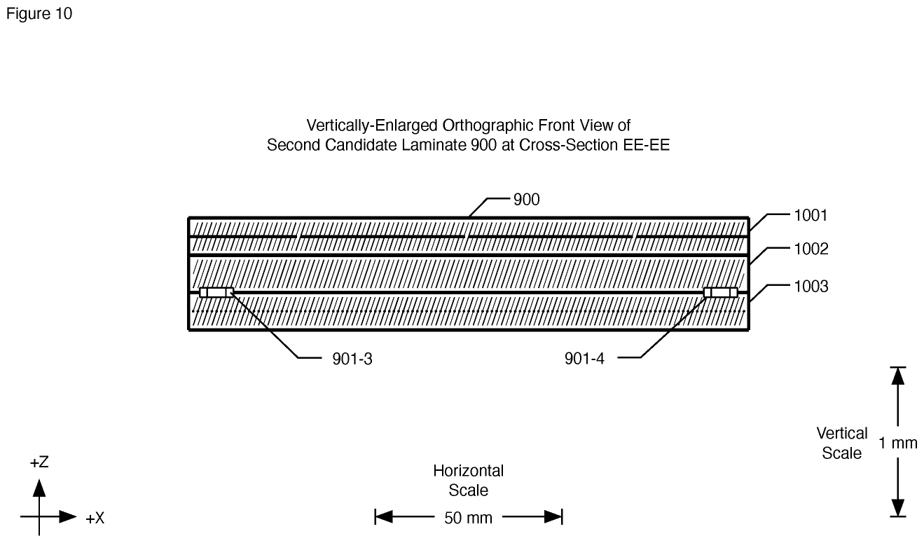

FIGS. 9a and 9b depict orthographic top and front views of second candidate laminate 900, and FIG. 10 depicts a vertically-enlarged orthographic front view of second candidate laminate 900 at cross-section EE-EE. To make the composition of second candidate laminate 900 easier for the reader to understand, the vertical (Δz) scale in FIG. 10 is different than the horizontal (Δx) scale. The overall dimensions of second candidate laminate 900 are 150.0 wide (Δx) by 100.0 mm high (Δy) by 0.750 mm thick (Δz).

Second candidate laminate 900 comprises three layers:
(i) fiber-reinforced thermoplastic layer 1001, and
(ii) un-reinforced thermoplastic layer 1002, and
(iii) fiber-reinforced thermoplastic layer 1003, and
   four flat washers:
(iv) flat washer 901-1, and
(v) flat washer 901-2, and
(vi) flat washer 901-3, and
(vii) flat washer 901-4.

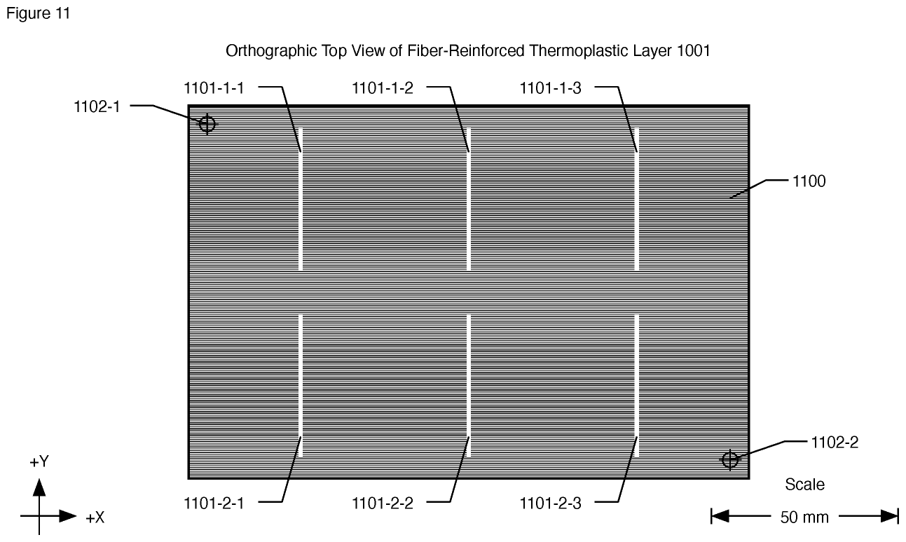

Fiber-Reinforced Thermoplastic Layer 1001—The principal purpose of fiber-reinforced thermoplastic layer 1001 is identical to fiber-reinforced thermoplastic layer 501. The design of fiber-reinforced thermoplastic layer 1001 is different, however, from the design of fiber-reinforced thermoplastic layer 501. FIG. 11 depicts an orthographic top view of fiber-reinforced thermoplastic layer 1001, which is identical to fiber-reinforced thermoplastic layer 501 except that some of the fibers have been severed, as shown, to facilitate thermoforming.

In accordance with the illustrative embodiment, layer 1001 comprises six (6) cuts but it will be clear to those skilled in the art, after reading this disclosure, how to make and use alternative embodiments of the present invention in which a layer of continuous fibers comprises any number of cuts.

In accordance with the illustrative embodiment, each of the six (6) cuts in layer 1001 is 3.8 cm long and 100μ wide, but it will be clear to those skilled in the art, after reading this disclosure, how to make and use alternative embodiments of the present invention in which each cut has any length (e.g., 100μ, 250μ, 500μ, 1000μ, 2.5 mm, 5 mm, 10 mm, 25 mm, 50 mm, 100.0 mm, 250 mm, 500 mm, 1000 mm, etc.) and any width (e.g., 10μ, 25μ, 50μ, 100μ, 250μ, 500μ, etc.). Furthermore it will be clear to those skilled in the art, after reading this disclosure, how to make and use alternative embodiments of the present invention in which one or more cuts has a different length than one or more other cuts.

In accordance with the illustrative embodiment, each of the six (6) cuts in layer 1001 straight (i.e., is a linear curve), but it will be clear to those skilled in the art, after reading this disclosure, how to make and use alternative embodiments of the present invention in which one or more of the cuts is not straight (i.e., is a non-linear curve).

In accordance with the illustrative embodiment, each of the six (6) cuts in layer 1001 is perpendicular to the fibers that are severed. It will be clear to those skilled in the art, after reading this disclosure, how to make and use alternative embodiments of the present invention in which one of more of the cuts is not perpendicular to the fibers.

In accordance with the illustrative embodiment, some of the fibers in layer 1001 are uncut. In contrast, some of the fibers in layer 1001 are severed into four collinear fiber segments by cuts 1101-i-1, 1101-i-2, and 1101-i-3, where i is a positive integer selected from the set i ∈ {1, 2}. It will be clear to those skilled in the art, after reading this disclosure, how to make and use alternative embodiments of the present invention in which:
(i) one or more fibers in a layer are not severed (i.e., are uncut), or
(ii) one or more fibers in a layer are severed into n collinear fiber segments, where n is a positive integer great than one (e.g., 2, 3, 4, 5, 6, 7, 8, 9, 10, 12, etc.), or
(iii) any combination of i and ii.

In accordance with the illustrative embodiment, the six (6) cuts form a two-dimensional first pattern of cuts in general, and a three by two array of cuts. It will be clear to those skilled in the art, after reading this disclosure, how to make and use alternative embodiments of the present invention in which two or more cuts form any one- or two-dimensional pattern.

Un-reinforced Thermoplastic Layer 1002—The principal purpose of un-reinforced thermoplastic layer 1002 is identical to un-reinforced thermoplastic layer 502 and un-reinforced thermoplastic layer 1002 is identical to un-reinforced thermoplastic layer 502.

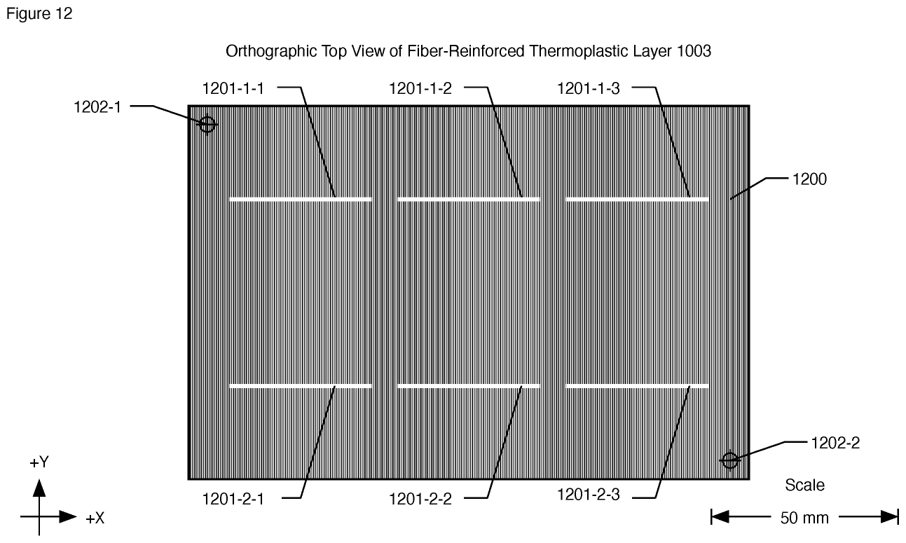

Fiber-Reinforced Thermoplastic Layer 1003—The principal purpose of fiber-reinforced thermoplastic layer 1003 is identical to fiber-reinforced thermoplastic layer 503. The design of fiber-reinforced thermoplastic layer 1003 is different, however, from the design of fiber-reinforced thermoplastic layer 503. FIG. 12 depicts an orthographic top view of fiber-reinforced thermoplastic layer 1003, which is identical to fiber-reinforced thermoplastic layer 503 except that some of the fibers have been severed, as shown, to facilitate thermoforming.

In accordance with the illustrative embodiment, layer 1003 comprises six (6) cuts but it will be clear to those skilled in the art, after reading this disclosure, how to make and use alternative embodiments of the present invention in which a layer of continuous fibers comprises any number of cuts.

In accordance with the illustrative embodiment, each of the six (6) cuts in layer 1003 is 3.8 cm long and 100μ wide, but it will be clear to those skilled in the art, after reading this disclosure, how to make and use alternative embodiments of the present invention in which each cut has any length (e.g., 100μ, 250μ, 500μ, 1000μ, 2.5 mm, 5 mm, 10 mm, 25 mm, 50 mm, 100.0 mm, 250 mm, 500 mm, 1000 mm, etc.) and any width (e.g., 10μ, 25μ, 50μ, 100μ, 250μ, 500μ, etc.). Furthermore it will be clear to those skilled in the art, after reading this disclosure, how to make and use alternative embodiments of the present invention in which one or more cuts has a different length than one or more other cuts.

In accordance with the illustrative embodiment, each of the six (6) cuts in layer 1003 is straight (i.e., is a linear curve), but it will be clear to those skilled in the art, after reading this disclosure, how to make and use alternative embodiments of the present invention in which one or more of the cuts is not straight (i.e., is a non-linear curve).

In accordance with the illustrative embodiment, each of the six (6) cuts in layer 1003 is perpendicular to the fibers that are severed. It will be clear to those skilled in the art, after reading this disclosure, how to make and use alternative embodiments of the present invention in which one of more of the cuts is not perpendicular to the fibers.

In accordance with the illustrative embodiment, some of the fibers in layer 1003 are uncut. In contrast, some of the fibers in layer 1003 are severed into three collinear fiber segments by cuts 1201-i-1, 1201-i-2, and 1201-i-3, where i is a positive integer selected from the set i ∈ {1, 2}. It will be clear to those skilled in the art, after reading this disclosure, how to make and use alternative embodiments of the present invention in which:
(i) one or more fibers in a layer are not severed (i.e., are uncut), or
(ii) one or more fibers in a layer are severed into n collinear fiber segments, where n is a positive integer great than one (e.g., 2, 3, 4, 5, 6, 7, 8, 9, 10, 12, etc.), or
(iii) any combination of i and ii.

In accordance with the illustrative embodiment, the six (6) cuts form a two-dimensional first pattern of cuts in general, and a two-by-three array of cuts. It will be clear to those skilled in the art, after reading this disclosure, how to make and use alternative embodiments of the present invention in which two or more cuts form any one- or two-dimensional pattern.

In accordance with the illustrative embodiment, the orientation of the fibers in layer 1003 is 90° different than the orientation of the fibers in layer 1001. It will be clear to those skilled in the art, after reading this disclosure, how to make and use alternative embodiments of the present invention in which the orientation of fibers in different layers is any angle (e.g., 0°, 15°, 22.5°, 45°, 67.5°, 75°, 90°, etc.).

The lateral location of the cuts in layer 1001 must be precisely aligned with the lateral location of the cuts in layer 1003, and, therefore the lateral location of layer 1001 and layer 1003 must be precisely aligned when the laminate is fabricated in task 104. Furthermore, the lateral alignment of the cuts in layer 1001 and layer 1003 must be precisely aligned with the mold when the laminate is thermoformed in task 105.

To facilitate the alignment of the cuts in layer 1001 and layer 1003, registration marks 1102-1 and 1102-2 are added to the top side of layer 1001, and registration marks 1202-1 and 1202-2 are added to the top side of layer 1003. In accordance with the illustrative embodiment, registration marks 1102-1 and 1102-2 are laser etched onto layer 1001 and registration marks 1202-1 and 1202-2 are laser etched onto layer 1003, but it will be clear to those skilled in the art, after reading this disclosure, how to make and use alternative embodiments of the present invention in which the registration marks are added with another method (e.g., silk screening, ink jet printing, embossing, etc.).

To facilitate the alignment of the cuts in layers 1001 and 1003 with mold 2200 in task 105, registration marks are also added to the top layer of the laminate. In this case, layer 1001 is the top layer of the laminate, and, therefore, registration marks 1102-1 and 1102-2 can serve to laterally align the laminate with the mold.

Flat washers 901-1, 901-2, 901-3, and 901-4—The principal purpose of flat washers 901-1, 901-2, 901-3, and 901-4 is identical to the purpose of flat washers 401-1, 401-2, 401-3, and 401-4, and flat washers 901-1, 901-2, 901-3, and 901-4 are identical to, and identically situated, as flat washers 401-1, 401-2, 401-3, and 401-4.

At task 302, the engineer determines if the article can be thermoformed from second candidate laminate 900 and if the resulting article with satisfy the required geometry of cover 200.

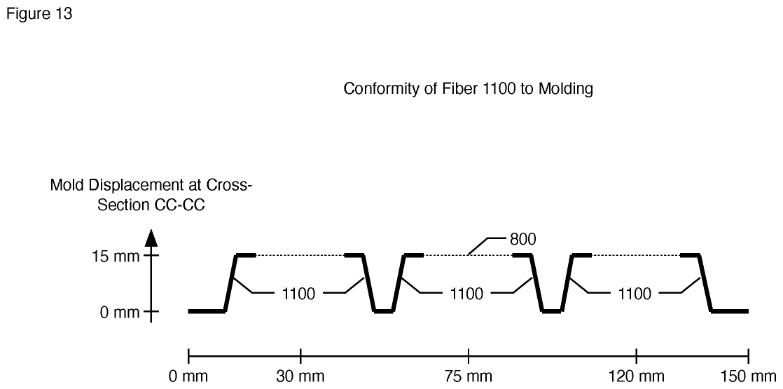

FIG. 13 depicts a diagram of how well one representative fiber in second candidate laminate 900 is predicted to deform during thermoforming. The engineer must perform this analysis on all of the fibers in second candidate laminate 900, but this is the analysis for one representative fiber.

The representative fiber is fiber 1100, as shown in FIG. 11. It is located at cross-section CC-CC, as shown in FIGS. 2a, 2b, and 2d. Fiber 1100 is 150.0 long and parallel to the X-axis. Fiber 1100 is clamped at both ends so that the ends cannot move.

The length of contour 800 is approximately 222 mm long, but fiber 900 is only 150.0 long. Unlike fiber 600, however, fiber 110 has been severed in three places—at 30 mm, at 75 mm, and at 120 mm. Although fiber 1100 will not stretch, the four collinear fiber segments into which fiber 1100 has been severed will conform to a total of 150.0 of the contour, as shown in FIG. 13. Therefore, second candidate laminate 900 will satisfy the required geometry of cover 200, as specified in task 101.

At task 303, the engineer next determines if the article thermoformed from the second candidate laminate 900 will satisfy the physical requirements of cover 200, as specified in task 101. In accordance with the illustrative embodiment, the engineer accomplishes this by performing finite element analysis on a model of the laminate after it has been molded into the article considering which areas have fiber and which do not.

The cuts in some of the fibers in second candidate laminate 900 enabled the laminate to be thermoformed but prevented the previously continuous fibers from spanning the entire width of cover 200. Furthermore, the location of the cuts dictates where the fibers will be present and where they will be absent.

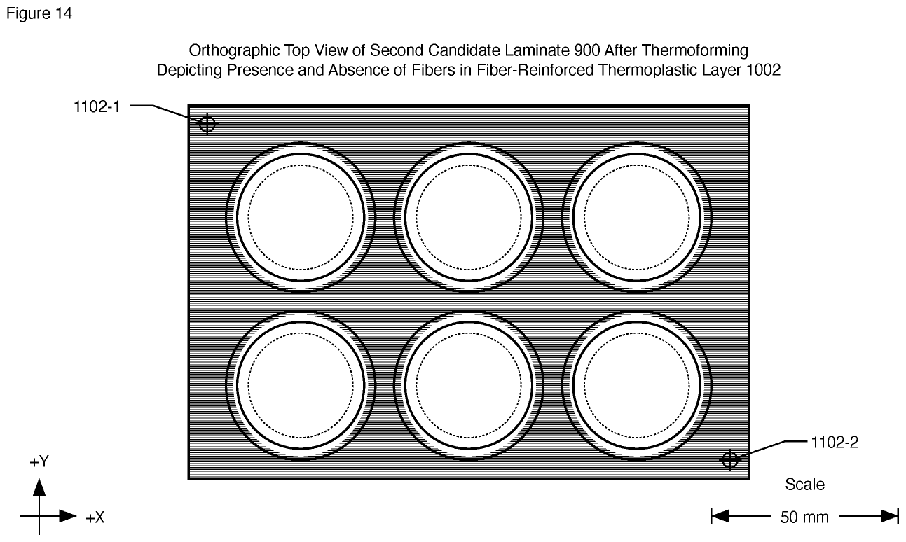

FIG. 14 depicts an orthographic top view of second candidate laminate 900 after thermoforming, which details where fibers in fiber-reinforced thermoplastic layer 1001 are present and where they are absent. In FIG. 14 it can be seen that the location of the cuts resulted in large areas in layer 1001 that are devoid of fiber.

Depending on the physical requirements of cover 200, this might be acceptable or unacceptable, and it will be clear to those skilled in the art how to discern the difference. In accordance with the illustrative embodiment, the physical requirements of cover 200 are not satisfied by second candidate laminate 900, and, therefore, control returns to task 301, where a third candidate laminate is designed.

At task 301, an engineer considers why second candidate laminate 900 was unsatisfactory and produces a third design for the laminate—third candidate laminate 1500—which the engineer hopes will overcome the deficiencies of second candidate laminate 900.

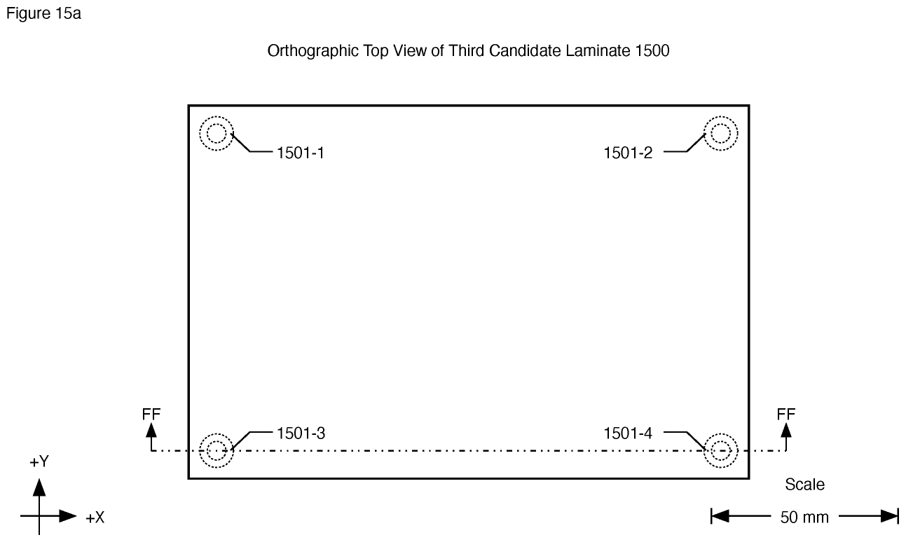

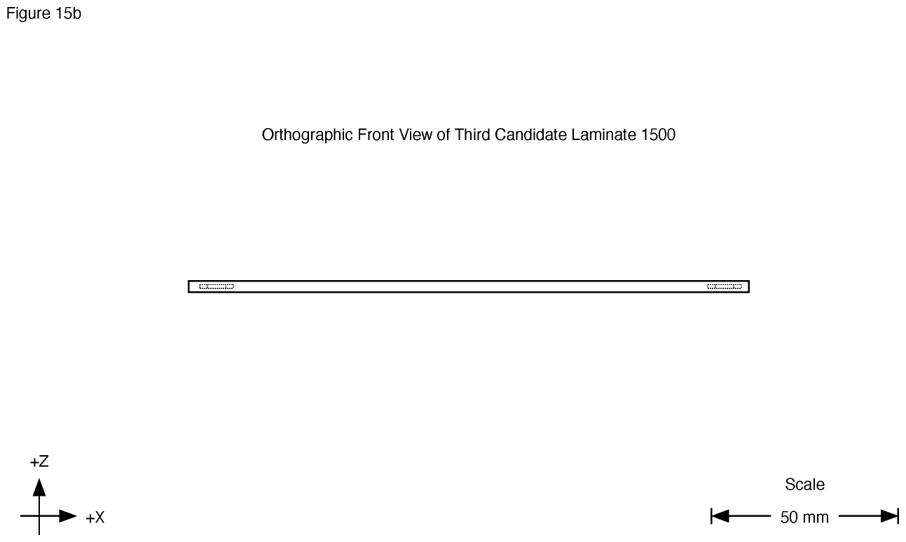

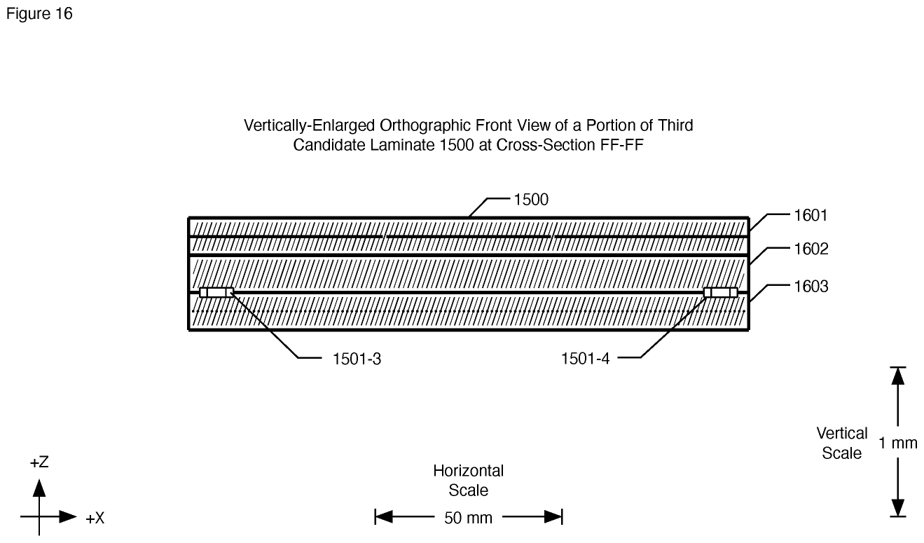

FIGS. 15a and 15b depict orthographic top and front views of third candidate laminate 1500, and FIG. 16 depicts a vertically-enlarged orthographic front view of third candidate laminate 1500 at cross-section FF-FF. To make the composition of third candidate laminate 1500 easier for the reader to understand, the vertical (Δz) scale in FIG. 16 is different than the horizontal (Δx) scale. The overall dimensions of third candidate laminate 1500 are 150.0 wide (Δx) by 100.0 mm high (Δy) by 0.750 mm thick (Δz).

Third candidate laminate 1500 comprises three layers:
(i) fiber-reinforced thermoplastic layer 1601, and
(ii) un-reinforced thermoplastic layer 1602, and
(iii) fiber-reinforced thermoplastic layer 1603, and
   four flat washers:
(iv) flat washer 1501-1, and
(v) flat washer 1501-2, and
(vi) flat washer 1501-3, and
(vii) flat washer 1501-4.

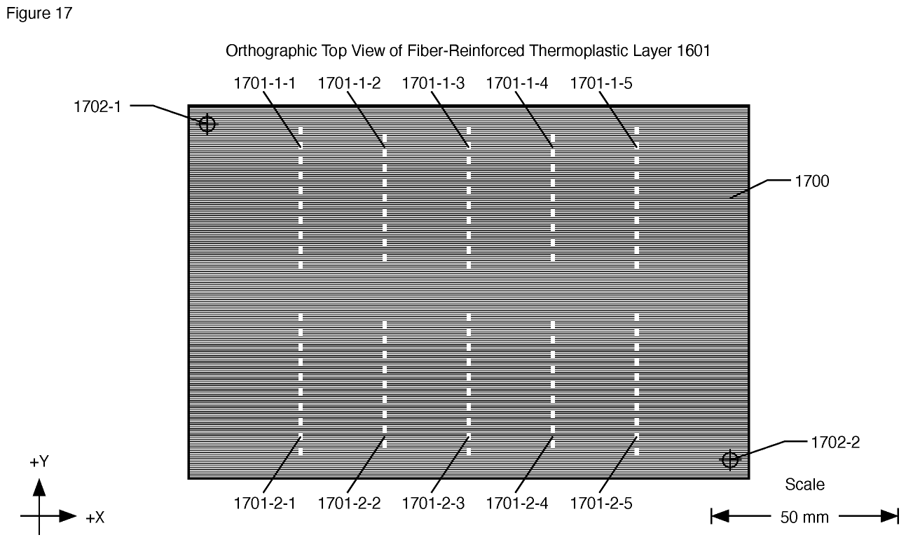

Fiber-Reinforced Thermoplastic Layer 1601—The principal purpose of fiber-reinforced thermoplastic layer 1601 is identical to fiber-reinforced thermoplastic layer 1001. The design of fiber-reinforced thermoplastic layer 1601 is different, however, from the design of fiber-reinforced thermoplastic layer 1001. In particular, the number and location of cuts has been changed. FIG. 17 depicts an orthographic top view of fiber-reinforced thermoplastic layer 1601, which is identical to fiber-reinforced thermoplastic layer 1601 except for the number and location of cuts, as shown.

In accordance with the illustrative embodiment, layer 1601 comprises 96 cuts but it will be clear to those skilled in the art, after reading this disclosure, how to make and use alternative embodiments of the present invention in which a layer of continuous fibers comprises any number of cuts.

In accordance with the illustrative embodiment, each of the 96 cuts in layer 1601 is 2 mm long and 100μ wide, but it will be clear to those skilled in the art, after reading this disclosure, how to make and use alternative embodiments of the present invention in which each cut has any length (e.g., 100μ, 250μ, 500μ, 1000μ, 2.5 mm, 5 mm, 10 mm, 25 mm, 50 mm, 100.0 mm, 250 mm, 500 mm, 1000 mm, etc.) and any width (e.g., 10μ, 25μ, 50μ, 100μ, 250μ, 500μ, etc.). Furthermore it will be clear to those skilled in the art, after reading this disclosure, how to make and use alternative embodiments of the present invention in which one or more cuts has a different length than one or more other cuts. Furthermore it will be clear to those skilled in the art, after reading this disclosure, how to make and use alternative embodiments of the present invention in which one or more cuts has a different length than one or more other cuts. And still furthermore, it will be clear to those skilled in the art, after reading this disclosure, how to make and use alternative embodiments of the present invention in which the length of successive cuts in a cluster (either linear or non-linear) follows a pattern (e.g., 1 mm cut followed to a 2 mm cut followed by a 2.5 mm cut followed by a 1 mm cut, etc.).

In accordance with the illustrative embodiment, each of the 96 cuts in layer 1601 is straight (i.e., is a linear curve), but it will be clear to those skilled in the art, after reading this disclosure, how to make and use alternative embodiments of the present invention in which one or more of the cuts is not straight (i.e., is a non-linear curve).

In accordance with the illustrative embodiment, each of the 96 cuts in layer 1601 is perpendicular to the fibers that are severed. It will be clear to those skilled in the art, after reading this disclosure, how to make and use alternative embodiments of the present invention in which one of more of the cuts is not perpendicular to the fibers.

In accordance with the illustrative embodiment, the 96 cuts are members of ten clusters 1701-i-j, where i is an integer selected from the set i ∈ {1, 2} and j is an integer selected from the set ∈ {1, 2, 3, 4, 5}. In accordance with the illustrative embodiment, the 96 cuts are members of ten clusters, but it will be clear to those skilled in the art, after reading this disclosure, how to make and use alternative embodiments of the present invention in which some or all of the cuts are not members of a cluster. Furthermore, it will be clear to those skilled in the art, after reading this disclosure, how to make and use alternative embodiments of the present invention that comprise any number of clusters of cuts and any number of cuts that are not members of a cluster.

In accordance with the illustrative embodiment, the cuts in cluster 1701-i-j form a straight line (i.e., a linear curve), but it will be clear to those skilled in the art, after reading this disclosure, how to make and use alternative embodiments of the present invention in which the cuts in a cluster form:
(i) a non-linear curve, or
(ii) a geometric shape (e.g., a circle, an ellipse, a square, a rectangle, etc.), or
(iii) a one- or two-dimension pattern, or
(iv) are irregular.

In accordance with the illustrative embodiment, the cuts in each cluster are spaced 2 mm apart. It will be clear to those skilled in the art, after reading this disclosure, how to make and use alternative embodiments of the present invention in which adjacent cuts in a cluster have any spacing. Furthermore, it will be clear to those skilled in the art, after reading this disclosure, how to make and use alternative embodiments of the present invention in which the spacing between adjacent cuts follows a pattern (e.g., 1 mm space followed by a 2 mm space followed by a 3 mm space followed by a 1 mm space, etc.).

In accordance with the illustrative embodiment, clusters 1701-1-1, 1701-1-3, 1701-1-5, 1701-2-1, 1701-2-3, and 1701-2-5 each comprise ten cuts, and clusters 1701-1-2, 1701-1-4, 1701-2-2, and 1701-2-4 each comprise 9 cuts. It will be clear to those skilled in the art, after reading this disclosure, how to make and use alternative embodiments of the present invention in which:
(i) all clusters comprise the same number of cuts, or
(ii) some clusters comprise a different number of cuts than some other clusters.

In accordance with the illustrative embodiment, the cuts in clusters 1701-i-1, 1701-i-3, and 1701-i-5 sever each continuous fiber into four collinear fiber segments, and the cuts in clusters 1701-i-2 and 1701-i-4 sever each continuous fiber into three collinear fiber segments. It will be clear to those skilled in the art, after reading this disclosure, how to make and use alternative embodiments of the present invention in which:
(i) one or more fibers in a layer are not severed (i.e., are uncut), or
(ii) one or more fibers in a layer are severed into n collinear fiber segments, where n is a positive integer great than one (e.g., 2, 3, 4, 5, 6, 7, 8, 9, 10, 12, etc.), or
(iii) any combination of i and ii.

In accordance with the illustrative embodiment, the fibers severed by the cuts in clusters 1701-i-1, 1701-i-3, and 1701-i-5 flank the fibers severed by the cut in clusters 1701-i-2 and 1701-i-4. Conversely, some of the fibers severed by clusters 1701-i-2 and 1701-i-4 flank some of the fibers severed by the cuts in clusters 1701-i-1, 1701-i-3, and 1701-i-5. All of fibers flanked by the cuts in cluster 1701-1-1 are severed by the cuts in cluster 1701-1-2, and, therefore, for the purposes of this specification, cluster 1701-1-1 and 1701-1-2 are defined to be “complimentary” clusters. It will be clear to those skilled in the art, after reading this disclosure, how to make and use alternative embodiments of the present invention that comprise any number or arrangement of complimentary clusters.

In accordance with the illustrative embodiment, clusters 1701-i-1, 1701-i-3, and 1701-i-5 are offset from clusters 1701-i-2 and 1701-i-4 by about 22.5 mm. It will be clear to those skilled in the art, after reading this disclosure, how to make and use alternative embodiments of the present invention in which the offset between any complementary clusters is any distance.

In accordance with the illustrative embodiment, the ten clusters 1701-i-j form a two-dimensional first pattern of cuts in general, and a five by two array of cuts. It will be clear to those skilled in the art, after reading this disclosure, how to make and use alternative embodiments of the present invention in which two or more clusters form any one- or two-dimensional cuts.

Un-reinforced Thermoplastic Layer 1602—The principal purpose of un-reinforced thermoplastic layer 1602 is identical to un-reinforced thermoplastic layer 1002 and un-reinforced thermoplastic layer 1602 is identical to un-reinforced thermoplastic layer 1002.

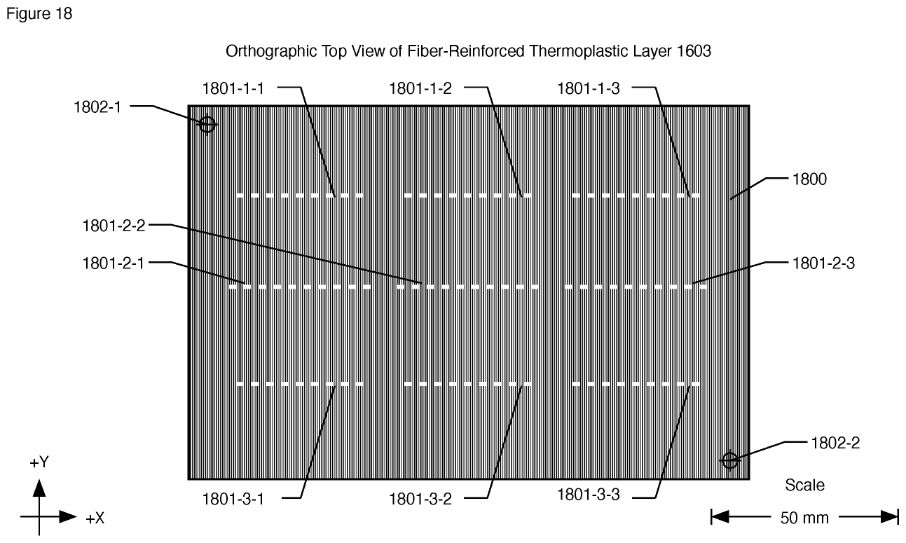

Fiber-Reinforced Thermoplastic Layer 1603—The principal purpose of fiber-reinforced thermoplastic layer 1603 is identical to fiber-reinforced thermoplastic layer 1003. The design of fiber-reinforced thermoplastic layer 1603 is different, however, from the design of fiber-reinforced thermoplastic layer 1003. In particular, the number and location of cuts has been changed. FIG. 18 depicts an orthographic top view of fiber-reinforced thermoplastic layer 1603, which is identical to fiber-reinforced thermoplastic layer 1003 except for the number and location of cuts, as shown.

In accordance with the illustrative embodiment, layer 1603 comprises 84 cuts but it will be clear to those skilled in the art, after reading this disclosure, how to make and use alternative embodiments of the present invention in which a layer of continuous fibers comprises any number of cuts.

In accordance with the illustrative embodiment, each of the 84 cuts in layer 1603 is 2 mm long and 100μ wide, but it will be clear to those skilled in the art, after reading this disclosure, how to make and use alternative embodiments of the present invention in which each cut has any length (e.g., 100μ, 250μ, 500μ, 1000μ, 2.5 mm, 5 mm, 10 mm, 25 mm, 50 mm, 100.0 mm, 250 mm, 500 mm, 1000 mm, etc.) and any width (e.g., 10μ, 25μ, 50μ, 100μ, 250μ, 500μ, etc.). Furthermore it will be clear to those skilled in the art, after reading this disclosure, how to make and use alternative embodiments of the present invention in which one or more cuts has a different length than one or more other cuts. Furthermore it will be clear to those skilled in the art, after reading this disclosure, how to make and use alternative embodiments of the present invention in which one or more cuts has a different length than one or more other cuts. And still furthermore, it will be clear to those skilled in the art, after reading this disclosure, how to make and use alternative embodiments of the present invention in which the length of successive cuts in a cluster follows a pattern (e.g., 1 mm cut followed to a 2 mm cut followed by a 2.5 mm cut followed by a 1 mm cut, etc.).

In accordance with the illustrative embodiment, each of the 84 cuts in layer 1603 is straight (i.e., is a linear curve), but it will be clear to those skilled in the art, after reading this disclosure, how to make and use alternative embodiments of the present invention in which one or more of the cuts is not straight (i.e., is a non-linear curve).

In accordance with the illustrative embodiment, each of the 84 cuts in layer 1603 is perpendicular to the fibers that are severed. It will be clear to those skilled in the art, after reading this disclosure, how to make and use alternative embodiments of the present invention in which one of more of the cuts is not perpendicular to the fibers.

In accordance with the illustrative embodiment, the 84 cuts are members of nine clusters—cluster 1801-i-j, where i and j are integers selected from the set i,j ∈ {1, 2, 3}. In accordance with the illustrative embodiment, the 84 cuts are members of nine clusters, but it will be clear to those skilled in the art, after reading this disclosure, how to make and use alternative embodiments of the present invention in which some or all of the cuts are not members of a cluster. Furthermore, it will be clear to those skilled in the art, after reading this disclosure, how to make and use alternative embodiments of the present invention that comprise any number of clusters of cuts and any number of cuts that are not members of a cluster.

In accordance with the illustrative embodiment, the cuts in cluster 1801-i-j form a straight line (i.e., a linear curve), but it will be clear to those skilled in the art, after reading this disclosure, how to make and use alternative embodiments of the present invention in which the cuts in a cluster form:
(i) a non-linear curve, or
(ii) a geometric shape (e.g., a circle, an ellipse, a square, a rectangle, etc.), or
(iii) a one- or two-dimension pattern, or
(iv) are irregular.

In accordance with the illustrative embodiment, the cuts in each cluster are spaced 2 mm apart. It will be clear to those skilled in the art, after reading this disclosure, how to make and use alternative embodiments of the present invention in which adjacent cuts in a cluster have any spacing. Furthermore, it will be clear to those skilled in the art, after reading this disclosure, how to make and use alternative embodiments of the present invention in which the spacing between adjacent cuts follows a pattern (e.g., 1 mm space followed by a 2 mm space followed by a 3 mm space followed by a 1 mm space, etc.).

In accordance with the illustrative embodiment, cluster 1801-2-j comprises ten (10) cuts, and cluster 1801-1-j and 1801-3-j comprises nine (9) cuts. It will be clear to those skilled in the art, after reading this disclosure, how to make and use alternative embodiments of the present invention in which:
(i) all clusters comprise the same number of cuts, or
(ii) some clusters comprise a different number of cuts than some other clusters.

In accordance with the illustrative embodiment, the cuts in cluster 1801-2-j severs each continuous fiber into two collinear fiber segments, and the cuts in cluster 1801-1-j and 1801-3-j sever each continuous fiber into three collinear fiber segments. It will be clear to those skilled in the art, after reading this disclosure, how to make and use alternative embodiments of the present invention in which:
(i) one or more fibers in a layer are not severed (i.e., are uncut), or
(ii) one or more fibers in a layer are severed into n collinear fiber segments, where n is a positive integer great than one (e.g., 2, 3, 4, 5, 6, 7, 8, 9, 10, 12, etc.), or
(iii) any combination of i and ii.

In accordance with the illustrative embodiment, the fibers severed by the cuts in cluster 1801-2-j flank the fibers severed by the cuts in clusters 1801-1-j and 1801-3-j. Conversely, some of the fibers severed by the cuts in clusters 1801-1-j and 1801-3-j flank the fibers severed by the cuts in cluster 1801-2-j. All of fibers flanked by the cuts in cluster 1801-2-1 are severed by the cuts in cluster 1801-1-1, and, therefore, for the purposes of this specification, cluster 1801-1-1 and 1801-2-1 are defined to be “complimentary” clusters. It will be clear to those skilled in the art, after reading this disclosure, how to make and use alternative embodiments of the present invention that comprise any number or arrangement of complimentary clusters.

In accordance with the illustrative embodiment, clusters 1801-1-j are offset from clusters 1801-2-j by about 22.5 mm, and clusters 1801-2-j are offset from clusters 1801-3-j by about 22.5 mm. It will be clear to those skilled in the art, after reading this disclosure, how to make and use alternative embodiments of the present invention in which the offset between any complementary clusters is any distance.

In accordance with the illustrative embodiment, the nine clusters 1801-i-j form a two-dimensional first pattern of cuts in general, and a three-by-three array of cuts. It will be clear to those skilled in the art, after reading this disclosure, how to make and use alternative embodiments of the present invention in which two or more clusters form any one- or two-dimensional cuts.

The lateral location of the cuts in layer 1601 must be precisely aligned with the lateral location of the cuts in layer 1603, and, therefore the lateral location of layer 1601 and layer 1603 must be precisely aligned when the laminate is fabricated in task 104. Furthermore, the lateral alignment of the cuts in layer 1601 and layer 1603 must be precisely aligned with the mold when the laminate is thermoformed in task 105.

To facilitate the alignment of the cuts in layer 1601 and layer 1603, registration marks 1702-1 and 1702-2 are added to the top side of layer 1601, and registration marks 1802-1 and 1802-2 are added to the top side of layer 1603. In accordance with the illustrative embodiment, registration marks 1702-1 and 1702-2 are laser etched onto layer 1601 and registration marks 1802-1 and 1802-2 are laser etched onto layer 1603, but it will be clear to those skilled in the art, after reading this disclosure, how to make and use alternative embodiments of the present invention in which the registration marks are added with another method (e.g., silk screening, ink jet printing, embossing, etc.).

To facilitate the alignment of the cuts in layers 1601 and 1603 with mold 2200 in task 105, registration marks are also added to the top layer of the laminate. In this case, layer 1601 is the top layer of the laminate, and, therefore, registration marks 1702-1 and 1702-2 can serve to laterally align the laminate with the mold.

Flat washers 1501-1, 1501-2, 1501-3, and 1501-4—The principal purpose of flat washers 1501-1, 1501-2, 1501-3, and 1501-4 is identical to the purpose of flat washers 901-1, 901-2, 901-3, and 901-4, and flat washers 1501-1, 1501-2, 1501-3, and 1501-4 are identical to, and identically situated, as flat washers 901-1, 901-2, 901-3, and 901-4.

At task 302, the engineer determines if the article can be thermoformed from third candidate laminate 1500 and if the resulting article with satisfy the required geometry of cover 200.

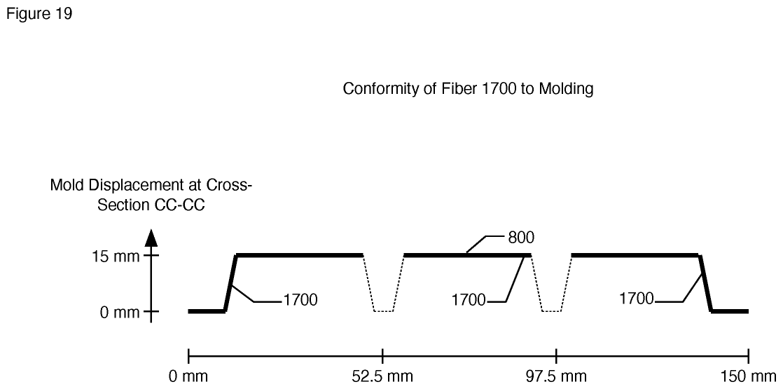

FIG. 19 depicts a diagram of how well one representative fiber in third candidate laminate 1500 is predicted to deform during thermoforming. The engineer must perform this analysis on all of the fibers in third candidate laminate 1500, but this is the analysis for one representative fiber.

The representative fiber is fiber 1700, as shown in FIG. 17. It is located at cross-section CC-CC, as shown in FIGS. 2a, 2b, and 2d. Fiber 1700 is 150.0 long and parallel to the X-axis.

The length of contour 800 is approximately 222 mm long, but fiber 1700 is only 150.0 long. Fiber 1700 has, however, been severed in two places—once at 52.5 mm and once at 97.5 mm. Because fiber 1700 has been severed into three collinear fiber segments, fiber 1700 will conform to 150.0 of the approximately 222 mm contour, albeit with two gaps of approximately 35 mm, as shown in FIG. 19. Therefore, third candidate laminate 1500 does, however, satisfy the required geometry of cover 200, as specified in task 101.

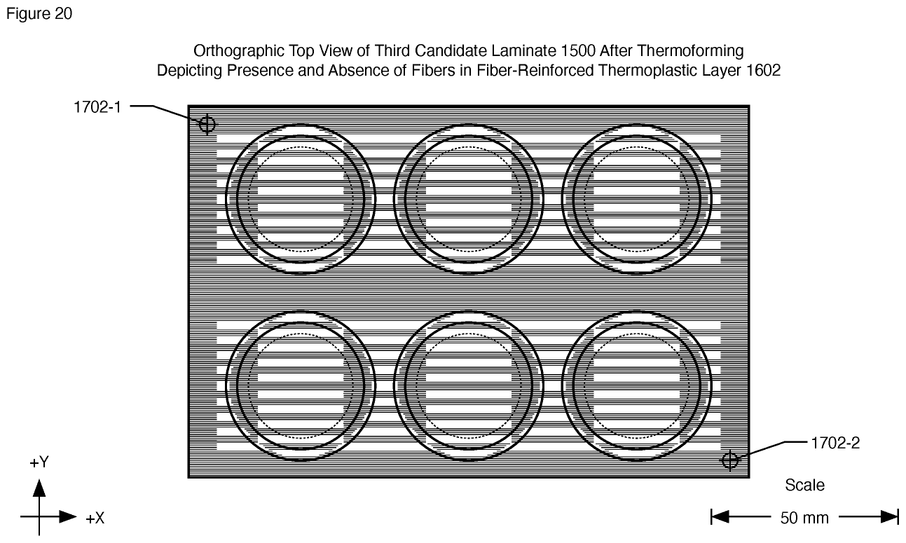

At task 303, the engineer next determines if the article thermoformed from the third candidate laminate 1500 will satisfy the physical requirements of cover 200, as specified in task 101. FIG. 20 depicts an orthographic top view of third candidate laminate 1500 after thermoforming depicting the locations where fibers in fiber-reinforced thermoplastic layer 1601 are present and where they are absent. In FIG. 21 is can be seen that the cuts to the fibers in fiber-reinforced thermoplastic layer 1601 before thermoforming caused thermoplastic to flow during thermoforming but, unlike second candidate laminate 900, there are no large areas that are devoid of fiber.

Depending on the physical requirements of cover 200, this might be acceptable or unacceptable, and it will be clear to those skilled in the art how to discern the difference. In accordance with the illustrative embodiment, the physical requirements of cover 200 are satisfied by third candidate laminate 1500, and, therefore, control passes to task 304.

At task 304, the engineer determines if the article thermoformed from third candidate laminate 1500 will satisfy the economic requirements of cover 200, as specified in task 101. If they do not, control returns to task 301, where another candidate laminate is designed. If they do, then control passes to task 103.

FIG. 21 depicts a flowchart of the salient subtasks associated with task 104—fabricating the fiber-reinforced thermoplastic laminate.

At task 2101, the fibers are severed in fiber-reinforced thermoplastic layer 1601 and 1603 as specified in task 301. In accordance with the illustrative embodiment, the fibers are severed with a laser, but it will be clear to those skilled in the art, after reading this disclosure, how to make and use alternative embodiments of the present invention in which the fibers are severed with a knife, high-pressure waterjet, hot wire, or electric arc.

At task 2102, layer 1601, layer 16021, layer 1603, flat washers 1501-1, 1501-2, 1501-3, and 1501-4 are assembled as designed in task 301 to form a layup, while using the registration marks to precisely align the cuts in layer 1601 with the cuts in layer 1603. It will be clear to those skilled in the art how to perform task 2202.

At task 2103, the layup assembled in task 2202 is formed into a fiber-reinforced thermoplastic laminate, in well-known fashion, in preparation for task 105.

After reading this specification, it will be clear to those skilled in the art how to make and use alternative embodiments of the present invention that comprise:
(i) a laminate of any dimensions; and
(ii) a laminate that comprises any number of layers; and
(iii) a laminate in which each layer comprises:
   thermoplastic embedded with reinforcing fiber, or
   thermoplastic without reinforcing fiber, or
   reinforcing fiber without thermoplastic; and
(iv) a laminate in which each layer has any dimensions; and
(v) a laminate in which each layer that comprises thermoplastic comprises any thermoplastic(s); and
(vi) a laminate in which each layer that comprises reinforcing fiber comprises any type of fiber (e.g., carbon, glass, aramid, hemp, etc.); and
(vii) a laminate in which each layer that comprises reinforcing fiber comprises continuous or chopped fiber; and
(viii) a laminate in which each layer that comprises reinforcing fiber comprises any number or density of fibers; and
(ix) a laminate in which each layer that comprises continuous reinforcing fiber comprises unidirectional or multidirectional weaves, braids, tows, etc.; and
(x) a laminate in which each layer that comprises continuous reinforcing fiber, comprises continuous fibers at any angular orientation; and
(xi) a laminate that comprises any number or type metallic or thermoplastic inserts or reinforcements; and
(xiii) a laminate that comprises any number or size of thermoplastic patches.

In accordance with the illustrative embodiment, the candidate layers composed polyethyletherketone (PEEK), but it will be clear to those skilled in the art, after reading this disclosure, how to make and use alternative embodiments of the present invention that are composed of any thermoplastic (e.g., polyaryletherketone (PAEK), polyetherketoneketone (PEKK), polyetheretherketoneketone (PEEKK), polyetherketoneetherketoneketone (PEKEKK), polyamide (PA), polybutylene terephthalate (PBT), poly(p-phenylene sulfide) (PPS), etc. When the thermoplastic comprises a blend of an amorphous polymer with a semi-crystalline polymer, the semi-crystalline polymer can one of the aforementioned materials and the amorphous polymer can be a polyarylsulfone, such as polysulfone (PSU), polyethersulfone (PESU), polyphenylsulfone (PPSU), polyethersulfone (PES), or polyetherimide (PEI). In some additional embodiments, the amorphous polymer can be, for example and without limitation, polyphenylene oxides (PPOs), acrylonitrile butadiene styrene (ABS), methyl methacrylate acrylonitrile butadiene styrene copolymer (ABSi), polystyrene (PS), or polycarbonate (PC).

What is claimed is:

1. A method comprising:
fabricating a fiber-reinforced thermoplastic laminate that comprises a first plurality of continuous fibers, wherein the first plurality of continuous fibers are parallel, wherein the first plurality of continuous fibers lie in a first plane, and wherein the first plurality of continuous fibers contain a first pattern of cuts.

2. The method of claim 1 wherein the location of the first plurality of cuts is based on a physical requirement of an article of manufacture.

3. The method of claim 1 wherein the location of the first plurality of cuts is based on a geometric requirement of an article of manufacture.

4. The method of claim 1 wherein the location of the first plurality of cuts is based on the displacement of a contour of an article of manufacture from the first plane.

5. The method of claim 1 wherein a first fiber in the first plurality of continuous fibers comprises at least two cuts, and wherein a second fiber in the first set of fiber comprises no cuts.

6. The method of claim 1 wherein the fiber-reinforced thermoplastic laminate further comprises chopped fiber that lies in a second plane that is parallel with the first plane.

7. The method of claim 1 wherein the fiber-reinforced thermoplastic laminate further comprises a second plurality of continuous fibers, wherein the second plurality of continuous fibers are parallel, wherein the second plurality of continuous fibers lie in a second plane, wherein the second plurality of continuous fibers contain a second pattern of cuts, and where the second plurality of continuous fibers are not parallel to the first plurality of continuous fibers.

8. The method of claim 1 wherein the first pattern of cuts comprises two complementary curves of cuts that are offset by a non-zero distance.

9. The method of claim 1 further comprising thermoforming the fiber-reinforced thermoplastic laminate into an article of manufacture.

10. A fiber-reinforced thermoplastic laminate comprising:
a first plurality of continuous fibers, wherein the first plurality of continuous fibers are parallel, wherein the first plurality of continuous fibers lie in a first plane, and wherein the first plurality of continuous fibers contain a first pattern of cuts.

11. The fiber-reinforced thermoplastic laminate of claim 10 wherein the location of the first plurality of cuts is based on a physical requirement of an article of manufacture.

12. The fiber-reinforced thermoplastic laminate of claim 10 wherein the location of the first plurality of cuts is based on a geometric requirement of an article of manufacture.

13. The fiber-reinforced thermoplastic laminate of claim 10 wherein the location of the first plurality of cuts is based on the displacement of a contour of an article of manufacture from the first plane.

14. The fiber-reinforced thermoplastic laminate of claim 10 wherein a first fiber in the first plurality of continuous fibers comprises at least two cuts, and wherein a second fiber in the first set of fiber comprises no cuts.

15. The fiber-reinforced thermoplastic laminate of claim 10 wherein the fiber-reinforced thermoplastic laminate further comprises chopped fiber that lies in a second plane that is parallel with the first plane.

16. The fiber-reinforced thermoplastic laminate of claim 10 wherein the fiber-reinforced thermoplastic laminate further comprises a second plurality of continuous fibers, wherein the second plurality of continuous fibers are parallel, wherein the second plurality of continuous fibers lie in a second plane, wherein the second plurality of continuous fibers contain a second pattern of cuts, and where the second plurality of continuous fibers are not parallel to the first plurality of continuous fibers.

17. The fiber-reinforced thermoplastic laminate of claim 10 wherein the first pattern of cuts comprises two complementary curves of cuts that are offset by a non-zero distance.

18. The fiber-reinforced thermoplastic laminate of claim 10 further comprising thermoforming the fiber-reinforced thermoplastic laminate into an article of manufacture.

19. A method comprising:
severing a first continuous fiber in a first layer of continuous fiber at a first cut to form a first fiber segment and a second fiber segment, wherein the first fiber segment and the second fiber segment are collinear;
severing a second continuous fiber in a second layer of continuous fiber at a second cut to form a third fiber segment and a fourth fiber segment, wherein the third fiber segment and the fourth fiber segment are collinear;
assembling and consolidating the first layer of continuous fiber and the second layer of continuous fiber into a fiber-reinforced thermoplastic laminate; and
thermoforming the fiber-reinforced thermoplastic laminate into an article of manufacture.
